(19) United States
(12) Patent Application Publication
(10) Pub. No.: US 2004/0193528 A1
(43) Pub. Date: Sep. 30, 2004

(54) Risk management for manufacturing

(76) Inventor: Mamoud Sadre, Windham, NH (US)

Correspondence Address: MAMOUD SADRE, 29 HICKORY LANE, WINDHAM, NH, 03087, US

(21) Appl. No.: 10/615,217

(22) Filed: Jul. 8, 2003

Related U.S. Application Data
(63) Continuation-in-part of application No. 09/640,272, filed on Aug. 17, 2000, now abandoned.

(51) Int. Cl. G06F 17/60

(52) U.S. Cl. 705/37

(57) ABSTRACT

The invention introduces financial risk management to producers by designing a semi-standard contract associated with generic product which, in turn, is based on root product. The invention focuses on the key elements of risk management, namely, financial instrument. The financial instrument has two components one is the product that may or may not be physical and the other is the contract related to the product. The system provides a methodology, for an industry sector, to extract root elements followed by generic product. A root product is defined as an element upon which all other (physical) products are developed. The process begins with building a sector's domain knowledge represented by tree. Root products will ideally be traded in a generalized hybrid trading platform designed to accommodate forward contracts. The platform provides risk management tools and integrates financial clearing and settlement.

### BACKGROUND OF THE INVENTION

1. Field of the Invention

This invention relates to developing risk management tools for manufacturing environment to achieve market efficiency.

2. Related Art

Pre-amble

The agricultural and mining businesses were, surely, the dominant industries in the United States by late 19^{th} century. After the Civil War a handful of people familiar with farming business developed an improved auction system for trading farm commodities that were not yet ready for delivery, but promised to be delivered sometime in future. The idea was to free the farmer (or consumer) from the risk of non-availability of buyer, (or of non delivery of commodity). About the same time, a similar phenomenon took place in England when some financiers decided to formulate a guarantee arrangement for the shipment of copper bar from Chile, headed towards British ports, whereby both shipper of goods in Chile and the buyer in Britain would be protected from unexpected events. The idea of transferring market risk from producer and consumer to risk takers has since evolved to an efficient formal marketplaces such as futures and options. Although the manufacturing sector has far surpassed the agricultural and mining industries, the extension of risk management to manufacturing sectors has not seriously taken place. The globalization of market economies is changing the way business in general, and manufacturing in particular, are conducted. In addition to the usual supply and demand factors, the huge inflows (and outflows) of capital from one market to another are creating a much larger market swing than the predictable seasonal or cyclical changes that occur from time to time. This stems from significant inter-manufacturing trades that take place routinely around the world. In a given environment there are risk elements that in normal circumstances are assumed to be known among the parties involved in the line of supply chain. Buyers and sellers in manufacturing sector expect a fixed price once an order is placed. They assume that the market conditions including currency and interest rates remain static during that period or if not each party is responsible for the risk involved.

In today's practices purchases and sales are made between any two parties in the old fashion way. A handshake. Such arrangements, known as forward contracts, bear a fixed price and promised delivery. A vast majority of these contracts remain exposed to risk; its significance has recently come to light mainly due to globalization of business activities. The manufacturing community has not yet addressed the question of shifting risk from tangible assets (the inventory ) to paper trading (securities).

Manufacturers are aware of the risk involved in building up inventory if the market goes soft because an untimely liquidation can be costly. Those who do not maintain inventory assume a similar risk. A sudden increase in the price of raw materials may cut into their profit. Minimizing the cost of storage or inventory, however, provides a strong and logical economic justification, considering the cost of money alone. The application of risk management will accommodate the manufacturers' inventory dilemma as well as stabilizing prices. It will end the boom and bust cycle by creating price stability in basic commodities. It also provides price transparency which helps market to become more efficient. Most significantly it lowers the cost to consumer by creating more competitive business environment

The risk factor

Risk is an element of uncertainty. Generally risks are typified as speculative or inherent; they are either static or dynamic. Risk management is a tool for removing the lack of knowledge about the type of risk. Risk is normally reduced or avoided by shifting it from, say, consumer to risk taker. A major risk in business is market risk. The market risk may generally be perceived as price, interest rate and currency exchange rate. Any movement in a price or rate will be undesirable to some market participants. Financial market innovations have sharply reduced many liquidity risks in recent years. Risk management, as a tool, can help minimize possible financial losses resulting from price changes. This technique is extensively used in futures industry. In all these cases formal exchanges facilitate the risk management by allowing the producer and consumer to transfer their business risk to risk takers.

Present practices in risk management

Risk management has been, of course, addressed in some businesses through traditional commodity exchanges. The mechanism of risk management is generally based on certain products representing a broad spectrum of industries ranging from agricultural to mining and financial. At present a limited number of products traded in such exchanges serve as bench mark for pricing the underlying commodity of a given industry. Crude oil is an example for petroleum industry. The market liquidity is then largely dependent on such selected product It should be noted that the specific product selected even though fully researched does not guarantee of being the right one and many tries are made before a successful launch of a product is proven. This interpretation of product selection is generally based on criteria practiced in traditional commodity exchanges. The criteria for product selection, presently tailored for floor trading model, include size, volatility, source of public information (such as supply and demand), existence of dealer community and most important, the liquidity factor which is considered an essential element for risk management.

Based on such products exchanges design “financial instruments”. Financial instruments are then used as the medium to shift financial risks. This implies that certain physical assets should be translated to financial instruments. The economic value of commodity trading, therefore, lies in its ability to transfer risk from the hedger (producer and consumer) to investors or risk takers. This is the basis for stabilizing price which accommodates a smooth supply chain within, say, the manufacturing community. The greatest achievement of financial instruments is to free, for example, manufacturer or supplier from commitment to holding contract until the goods are delivered or received at the expiration date. They can be traded as any other traditional securities

Problem of developing products

The extension of random product selection to other industries, as means of risk management tool, is difficult and costly due to several factors. Firstly, the number of products become limitless in, say, manufacturing as the value-added products continue to expand. Secondly, the dynamics of industry cause continuous changes in product specification and most important, the global trade requirements will render the existing rigid exchanges impractical for handling large number of products effectively. In contrast to standard contracts, non-standard contracts pose a higher risk for exchanges than standard contracts. Risks include those with bad credit (e.g., due to bankruptcy or foreclosure), non-performing contracts (e.g., late or non delivery of goods or non payment).

In view of the above; therefore what is needed is a system, method and computer program product for an online trading platform with flexible products and contracts implementing risk management. Such a system would create a “marketplace” in which producers and consumers of these financial instruments as well as investors could trade such products.

### SUMMARY OF THE INVENTION

The present invention is a system, method, and computer program product for the online trading of select manufactured products as financial instruments. In particular, the present invention provides flexible contracts based on root products. As such, the present invention provides risk management and a resource for dissemination of information for manufacturers and investors (e.g., market data producers and consumers performance, etc.). In this way, every individual involved in the manufacturing sector can access information stored in a marketplace trading manufactured products based on present invention.

One advantage of the present invention is global transparency of prices of key manufactured products leading to lowering consumer cost in consumer and durable goods.

Another feature of the present invention is that it reduces the amount of time and money when negotiating for the sale of a inter- manufacturing product which in turn reduces the cost of sale as well as cost of goods sold. This will ultimately reduce the cost of goods within manufacturing itself.

Another feature of this invention is the rationalization methodology upon which financial instruments as underlying commodity are developed. It is a computer assisted methodology that performs the selection process, market research and transformation of the root products into a financial instruments.

Another advantage of this invention is the ability of manufacturers to hedge their position when buying raw materials

Another advantage of this invention is the ability of manufacturers to hedge their position when selling finished goods.

Another advantage of the present invention is that it archives information about the manufactured products and bid/ask information to be used to determine a true price for the root products.

Further features and advantages of the invention as well as the structure and operation of various embodiments of the present invention are described in detail below with reference to the accompanying drawings.

### BRIEF DESCRIPTION OF DRAWINGS

FIG. 0—The trading platform trades semi-standard contracts that are based on generically specified root products. The platform provides risk management as well as disseminating information

FIG. 1—Trading platform shows its various facilities ranging from clearing and settlement to generation of liquidity

FIG. 3—Detailing the steps taken from analyzing a custom product to arriving at its root product

FIG. 4—The existing flow of forward contract process with respect to risk exposure

FIG. 5—The risk management flow diagram based on the invention

FIG. 6—The general format of flexible, semi-standard contract

FIG. 7—Modes of transaction in the hybrid trading platform

FIG. 8—Key integrated facilities within the trading platform

FIG. 8a—Detailing the cash management facility

FIG. 8b—Detailing physical delivery module

FIG. 9—Table showing an example of bunching delivery dates for calculating marked-to-market price

FIG. 10—Another viewing of bunching delivery dates

FIG. 015—Breakdown of a manufacturing part number

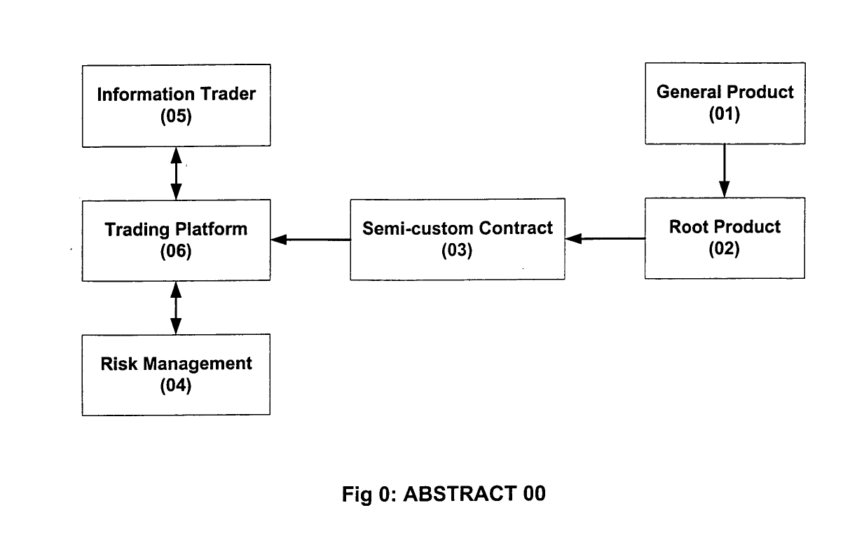

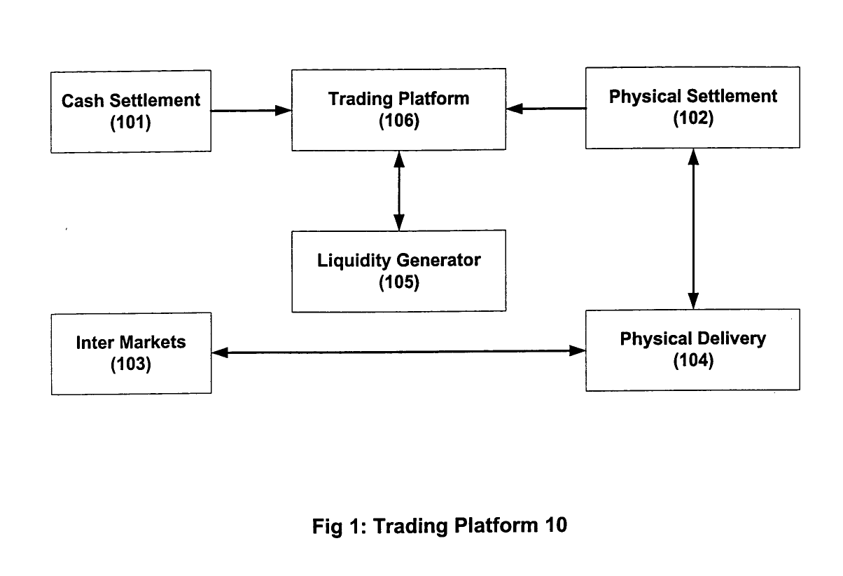

### DETAILED DESCRIPTION OF THE INVENTION

The sequence of events leading to an open market for a manufacturing sector is as follows

1. sectionalizing manufacturing stages in a given sector

2. identifying the in-process-materials

3. standard versus non-standard products

4. develop root product for non-standard products

5. design a dynamic contract based on root products

6. a multi-lateral forward trading platform

7. trading facilities for post trade

### Definitions

| | |
|---|---|
| Product | Root product based on generic specification |
| Root product | The root of specific end product as exemplified by a |
| | tree trunk and branches |
| In-process | Raw materials or materials-in progress |
| material | |
| Spot Market | Goods are delivered immediately upon purchase |
| Cash Market | Only cash is being used as a medium of transaction |
| Forwards | Any bi-lateral contract |
| Futures | A multi-lateral standard contract |
| Hybrid | Semi-custom, flexible contract |
| Financial | Any fungible product |
| instrument | |
| E-Commerce | Automatic coordination for door to door delivery |
| Logistics | |
| Dealer | An intermediary who assumes certain risk |
| Value-add | Labor, material and knowledge from one stage to next |

Defining In-Process-Materials

In any stage of manufacturing where one state of material is transformed to another certain value is added to the original state. This “value-add” consists of material physical or chemical) and fixed cost, including labor. In this analysis the material cost is considered as the variable element in measuring the value-add.

As an example of such in- process material consider a steel mill. The pig iron is acquired as raw material from the ore owner. The steel sheet is produced which bears a known value add. Depending on the application the steel sheet will be used as next raw material for auto manufacturer. In each stage of transformation the manufacturing fixed cost not withstanding, the “raw” material is the element whose price movement directly affect the value-add.

As another example, a utility company purchases generating electricity from power station and sells electricity at distribution level (known value-added) to municipality as raw material. The municipality will sell electricity at kilowatt-hour rate to residential units (known value-add). The in-process-material, here refers to kilowatt-hour cost at 132 Kilovolt versus that at 33 kilovolt, etc.

By sectionalizing all manufacturing levels numerous value-add materials, both tangible and non tangible, can be discovered. For example in electronics manufacturing sector there are semiconductors, power electronics, interconnect, opto-electronics, etc. The above process can go on and on.

For a targeted sector a “tree” is then constructed. The tree represents major product groups of that sector. Each group is further analyzed to search for the root product. To avoid unnecessary and cumbersome job of listing all and every product throughout the process the principal of Pareto's (Distribution) Law, commonly known as 80/20 rule, is adopted as a convenient tool.

The Existing Practice

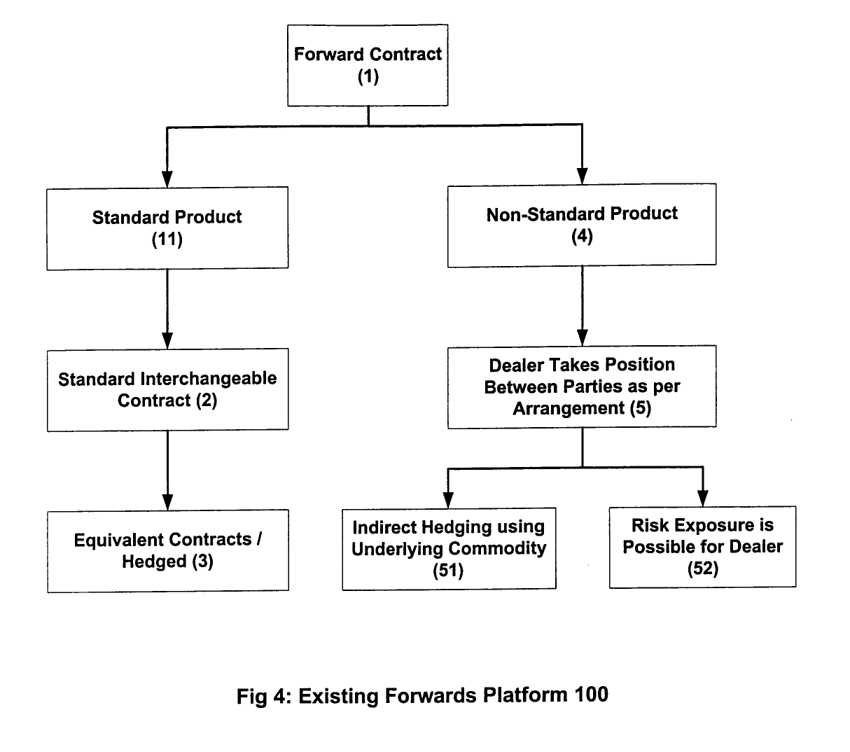

The common practice in acquiring raw materials is routine. A consuming manufacturer enters into a purchase “contract” with a selected producer either directly or through an authorized distributor. Such contract is an agreement between two parties as shown as block 1 in FIG. 4. based on a fully specified physical material. It is a typical forward contract which spells out particular conditions and terms including material specification, price and delivery term. These known value-add materials defined as “Products” are of two types:

A) Starting with FIG. 4 standard product is shown as block 11 which generally bears standard specifications. An example will be West Texas Intermediary (WTI) crude oil. Standard products accept no change in specification and have unlimited life span.

Standard products have the advantage of being incorporated into standard contract shown as block 2. These contracts are interchangeable and can repetitively be used between any two parties in trading environment. In this case if two parties enter into a forward contract for most standard products(for example gasoline) is a matter of calculating the equivalent of futures contracts to the exact quantity of contract and delivery terms to secure a “hedged” position; hence eliminating any potential risk as indicated in block 3. If the product is a derivative of underlying commodity an indexing procedure may be required to arrive at correct number of contracts. An example will be trading of fuel oil #6 based on the underlying commodity, namely, heating oil #2.

B) A non standard product, appear as forward contract shown in block 1. It represents any product for any application which may or may not be repetitive.

The non standard products generally result in non standard contract. A non-standard product or contract, shown as block 4, can not be interchanged, but it can be “managed” by a dealer who would guarantee the contract between the two parties under certain terms between each party and himself. In effect, the dealer assumes certain financial risk in case of default by either party. He has two choices for managing his own risk: Block 51 refers to a possible availability of open market for the underlying commodity. This is the case of a derivative. The example is a jeweler who manufactures gold ring. The underlying commodity, standard gold is traded in open market. In this case the dealer is able to “hedge” his position based on certain index.

Block 52 refers to most common case that the there exists no open market for the underlying commodity and the dealer is financially at risk. If either party defaults on such contract the only remedy is legal action by the injured party.

Homogenization Process

It is now clear why it is necessary to devise this “underlying commodity” which is the root product. The following paragraphs outline the process of arriving at that.

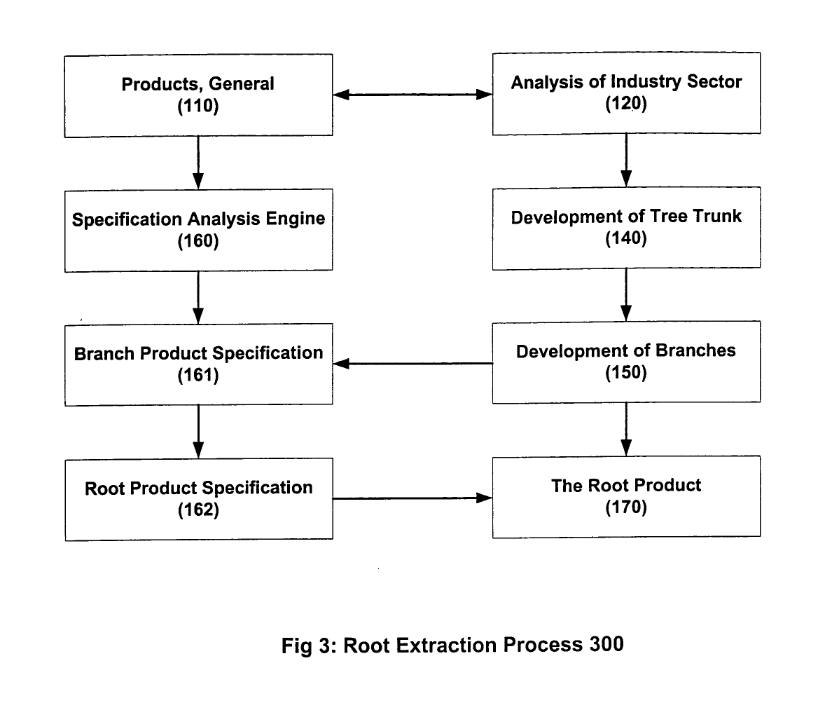

Starting with block 1 a product is assumed to be non standard which is ordinarily being handled through a typical forward contract (commonly known as contract) with a fixed price and delivery date(s), block 11. The process of going from block 1 to block 2 involves several steps as shown in FIG. 3.

The first stage requires a full analysis of industry sector with respect to its taxonomy of products as indicated by block 120. Block 110 represents a group of general unidentified products. Once the sector is established the next level involves development of a tree trunk for the sector, block 140. Such a trunk identifies all major products that branch out of the trunk of tree. Block 150 is another iteration of further branching to sub-sector, etc.

Once all major branches are identified any targeted product can be traced to its root product. After the branches and root products are identified, the search for commonality of specification begins. Block 160 represents sorting and comparing specifications of root products. This is described below:

Domain knowledge, a taxonomy of product:

Manufacturers continuously enhance their existing product and or develop new products to maintain or improve their market share. The objective here is to design a database to rapidly update, add and remove items within the “listed” product table to stay current. To start a taxonomy of manufactured product is shown below.

+Manufacturer Part number decoder

prefix identifying, manufacturer, trade mark, others

suffix identifying specification for a particular part

product classification identifying product group

identified root product

+Technical data

physical characteristic

electrical properties

environmental

material

+Specification

design feature

packaging/enclosure

organization

+standards

form factor

code

+technology

die

process

Based on this knowledge a step-by-step procedure for technical specification search is exemplified to show how the update is done.

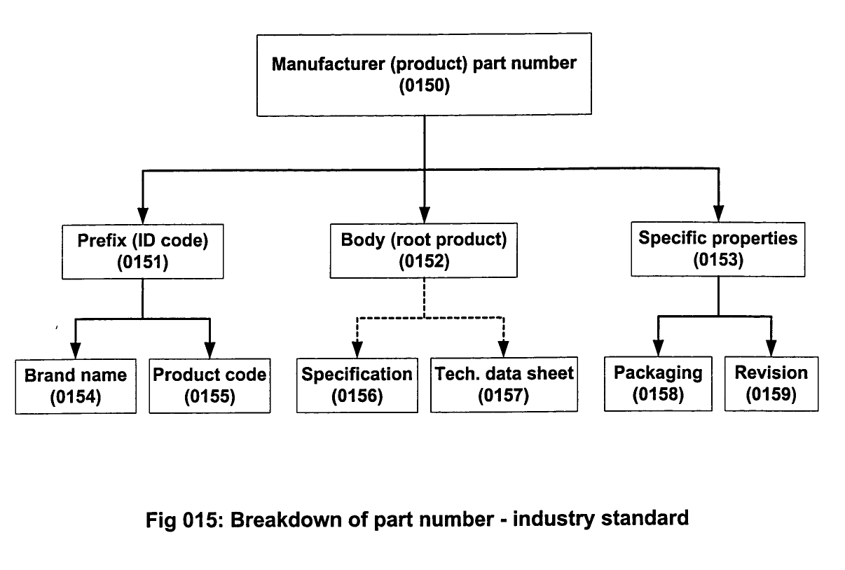

A) Starting with general product availability list of vendor the following steps are required. Referring to FIG. 015 a systematic extraction of product characteristics based on codes are shown as blocks. Blocks 0156 and 0157, however, refer to the specification and technical data sheets of the root product. Data about manufacturer's part numbering/coding and product category are stored in the database

List all items from vendor's list

Identify vendor (using vendors code table in database)

Extract the preliminary root (base) product by identifying prefix and suffix example: SN 74 F 373NT 1992

a. SN: Texas Instrument

b. Identify prefix:(prefix: 74F)

c. Identify suffix: (NT 1992: suffix)

d. strip b and c

e. Identify base product: (373)

f. Identify sub-sub-sub-subgroup: (flip/flop)

g—Identify sub-subgroup: (logic devices)

### The Database Will Contain

1. vendor reference (name, products relevant to selected group, product code) example:

| vendor | product group | product code |
|---|---|---|
| mosel vitelic | dram | v53c |
| mosel vitelic | sram | ms62 |
| texas instrumets | logics | sn74 |
| micron | ram | mt4 |
| nec | dram | mupd42 |

2. product coding (prefix-base-suffix-other) example: 1×4 mb dram, cmos, fast page(01-1-3)

| vendor | product part number | prefix | base | suffix | other |
|---|---|---|---|---|---|
| mosel vitelic | v53c404B p60L | v53c | 404 | Bp60L | |
| texas instr. | SN 74 F 373NT 1992 | SN 74 F | 373 | NT | 1992 |
| nec | mupd424400 LE70A | mupd42 | 4400 | LE70A | |
| micron | mt4c4001j | mt4c | 4001 | J | |
| hyundai | hy514400b | hy51 | 4400 | b | |

B) Temporarily store the item within the pre-defined group, sub-group, etc. In the above example: flip/flop, group 1-2-1-1-x

C) compare specifications for different vendors To do this a database is designed to capture, store and retrieve all the relevant technical data available by the vendors

Develop item ID/parent ID formulation

DEFINITION OF ID AND ITS PARENT ID

| ID | description | parent ID |
|---|---|---|
| an item/entity | what it is | item/other parents |
| Examples: | | |
| cmos | technology employed | technology |
| technology | engineering basis | technical data sheet |
| technical data sheet | technical specification | specification |
| fast page mode | rapid access | speed |
| 4mx4 | byte size in bits | organization |
| 18 pin | number of connections | Pin count |
| pin count | number of pins | physical properties |
| physical properties | appearance of product | specification |
| soj | method of enclosing | packaging |
| packaging | technique used for enclosing | physical properties |
| 0603, 0805, 1206 | EIA code for sizing | type |
| type | prod. by standard code | physical properties |

This is the critical database that will be the genesis of product specifications review and matching. The following examples demonstrate the way the initial product were selected as fitted into the ID/PARENT ID FORMAT:

GROUP 1-Integrated Circuits (IC)

ID: IC, Parent ID: electronics device

subgroup 1: memory devices

ID:memory device, Parent ID: Integrated Circuit devices

Sub-subgroup 1-1-1: dram

ID:dram, Parent ID: memory devices

Sub-sub-subgroup 1-1-1-1:

1 mxl, cmos, fast page mode, 60 ns, 5v

ID: CMOS , Parent ID: technolgy

ID: fast page mode, Parent ID: speed

ID: 5 v, Parent ID: technical data

ID: 1 mxl, Parent ID: organization

ID: 60 ns, Parent ID: access time

sub-sub-subgroup01-1-1-1-1:

ID: 18 pin, Parent ID: Pin count

ID:dip, parent ID: packaging

Sub-subgroup 1-1-2 : sram

ID:sram, parent ID: memory devices

Sub-sub-subgroup 1-1-2-1

item: sram, 32kx 8

ID:BiCMOS , parent ID: technology

ID: 128kx8, parent ID: organization

ID:plastic dip, parent ID: packaging

ID: 5 v, parent ID: technical data

ID:async, parent ID: technical data sheet

ID:32 pin, parent ID: pin count

sub-sub-subgroup 1-1-2-1- 1:

ID:20 ns, parent ID: access time

subgroup 1-2, logic

ID: logic devices, Parent ID: Integrated Circuit

item: 74hc00, nand gate

sub-subgroup 1-2-1 : cmos logic

ID: cmos, parent ID: technology

ID: 74hc series, parent ID: type

ID:00, parent ID: designated code

ID:−55 to 125 c, parent ID: physical properties

ID: soic , parent ID: packaging

sub-sub-subgroup 1-2-1-1-1:

2. Retrieve the stored item : compare and update specification:

a. Identify part ID against manufacturer

b. Identify part ID against production date

c. Compare part ID against new revision

d. update product table

D) Measuring the degree of relative importance of products

1. List all items required for purchase. Utilize Pareto's Law to arrive at desired value

a. Identify base product of a sub-group and exclude all quantities <lot size of the subgroup example: subgroup 1-2: 74F273, 74F 00, 74F11, etc. . . . ,

b. Calculate total purchase, both spot & contracts: quantity×price example: 10,000×$1.50+14,000×$1.20+ . . . =$40,000 of subgroup 1-2

c. multiply (b) by 0.8 example: $32,000

d. Quick sort on the order of highest value, i.e quantity times purchased price. example: there are 10 items of subgroup 1-2,

e. Add items downward until the total approaches or equals the figure obtained in (c) Example: the first two items total value ˜$32,000?

If not proceed as follows:

f. Iteration process

i. Tabulate the items that have produced the above figure.

ii. If total of selected items is greater than 20% of total numbers add 20% of items downward.

iii. Calculate subtotal value.

iv. If total is less than 80% of total add items downward until total approaches 80%

v. Repeat steps (i-iv) until 20% is reached within approximation.

g. List the items

example: 74F 373 74F 11

2. List all items offered for sale (spot and contracts)

Follow an identical approach to (1)

3. As this process continues and the listed items are tallied those products that appear most frequently in the lists would have the highest relative strength.

E) Add the stored item if (C) and (D) are satisfied

F) update or delete items based on last technical data revision, including phase-out and obsolescence

Finally the generic specification is attached to root product. This is indicated as block 170. This, generically specified, root product can then be interchangeable.

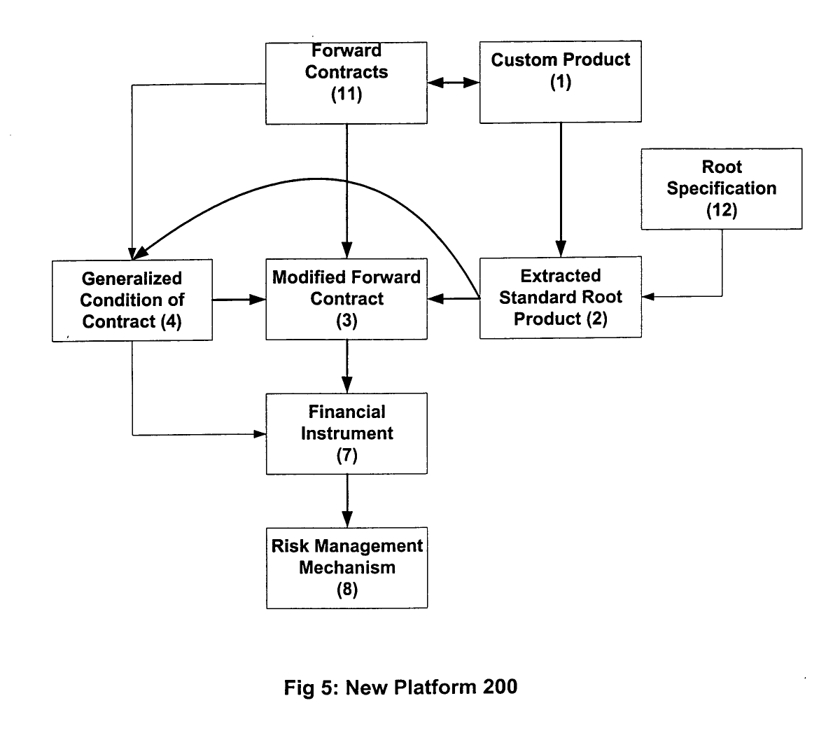

FIG. 5 shows how the invention creates a semi-standard contract that would behave as a financial instrument for a given product. These flexible semi standard contracts, encompassing most value-added products, are easily and quickly constructed based on root products.

Referring back to FIG. 5 the first step assumes that the root product is already extracted as shown in block 2. Such product is fed with a generic specification, block 12 derived from industry standards. The next step can split into two choices: (i) the Root product is sufficiently general to fit the standard contract with general conditions, block 4. In this case the contract will be interpreted as financial instrument, block 7. This kind of financial instrument can be traded in any conventional exchange. This means such a contract when traded in the platform can be traded in a multi-lateral manner instead of bilateral implying that it is “tradable” at any time between any two parties. (ii) the Root product is almost standard implying that some conditions of general contract will have to be modified as shown in block 3. FIG. 5 flow diagram shows that in this case the original forward contract, block 11 is now modified to represent a semi-custom, or semi- standard contract.

Semi-standard contract

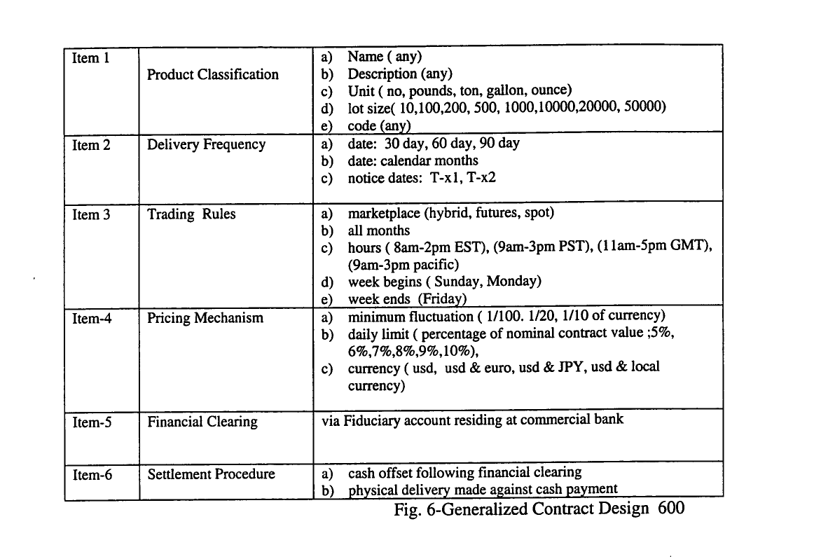

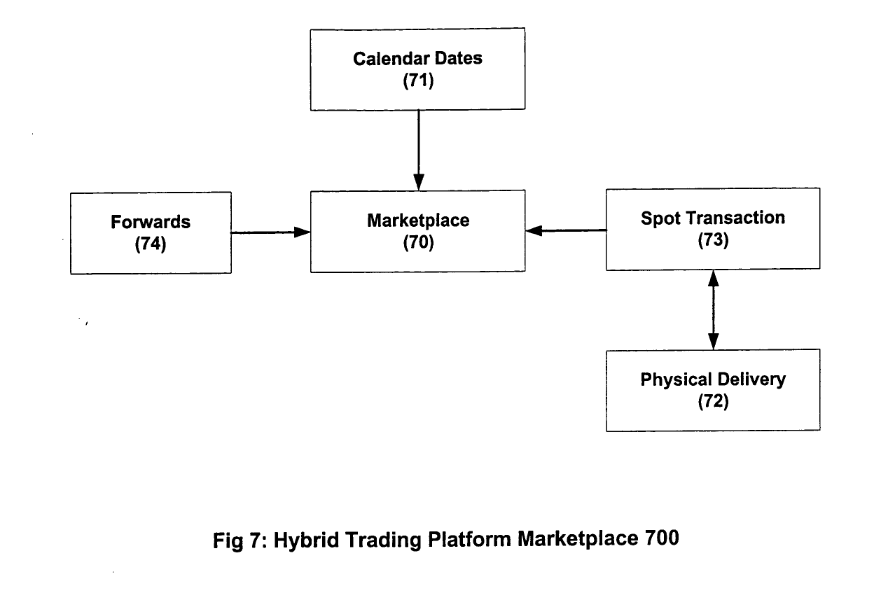

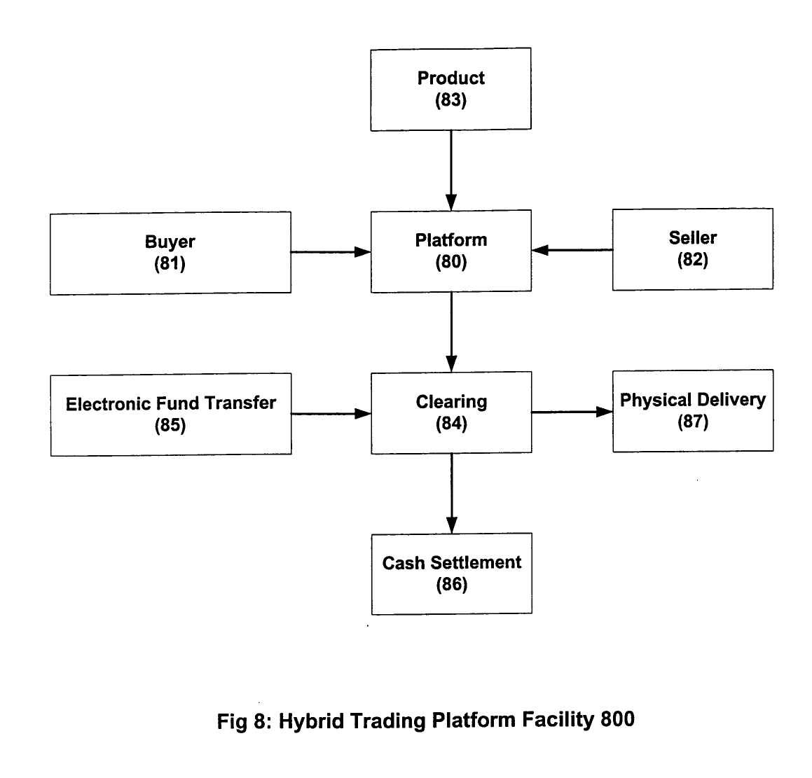

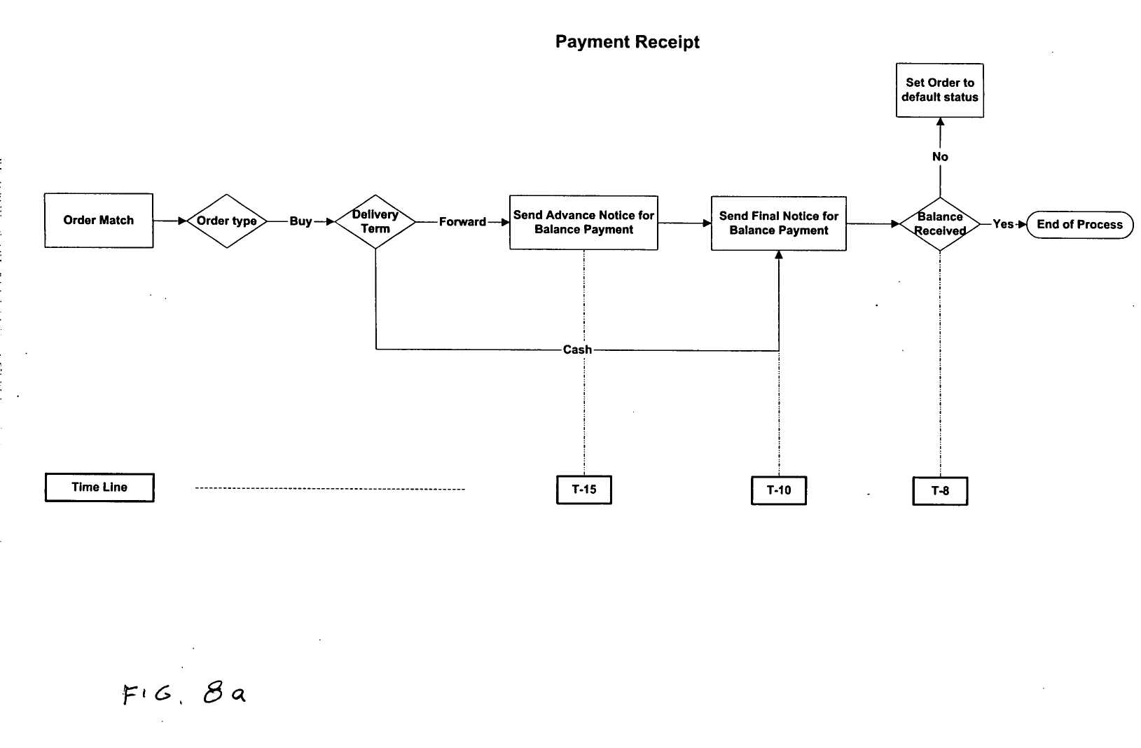

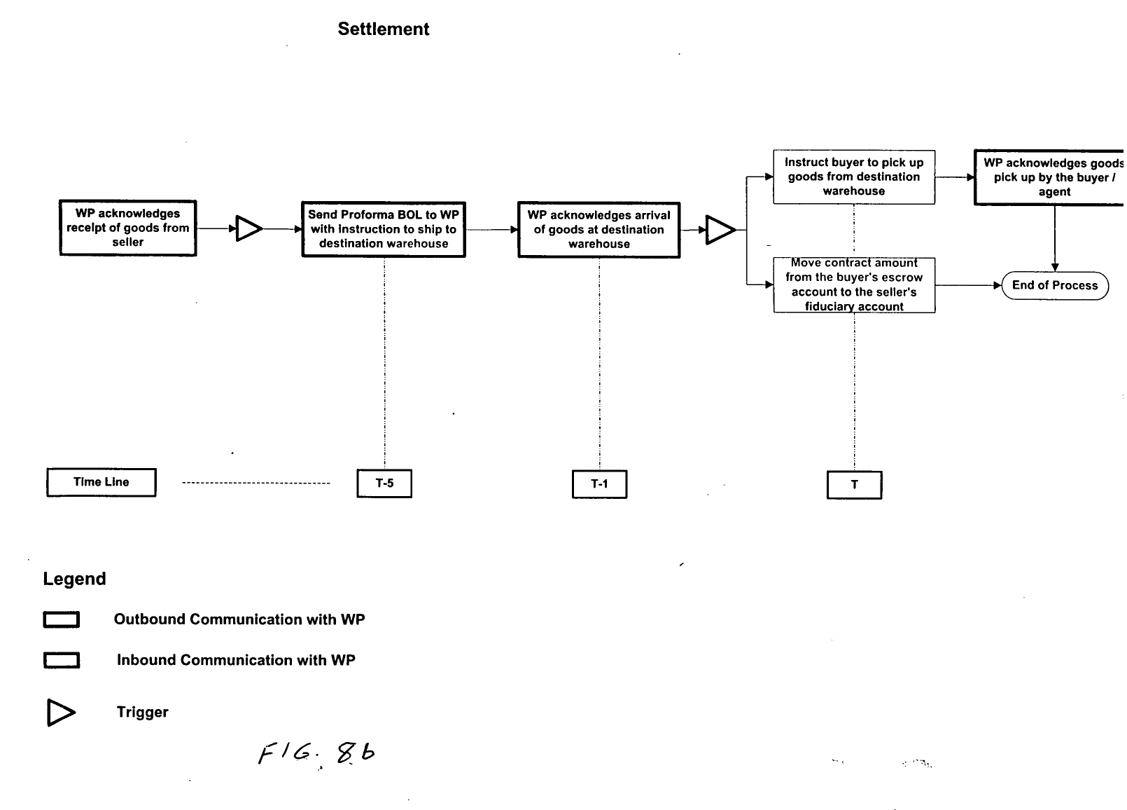

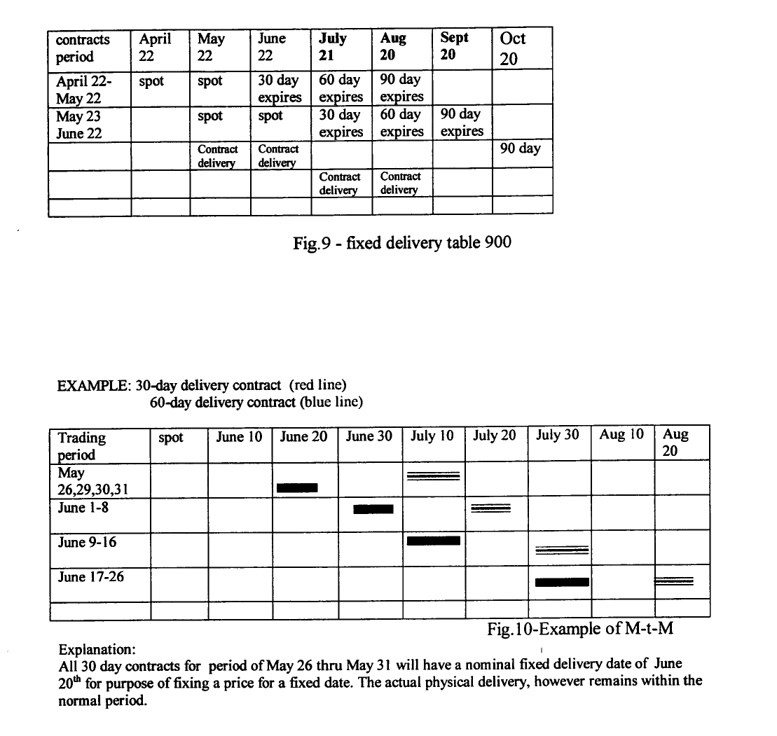

The main characteristics of contracts, is shown in FIG. 6. These elements indicate the generalized condition of contracts irrespective of buyer and seller particular conditions. The second column represents the major properties of the contract. The third column shows the product and marketplace dependency of these properties. This results in dynamic changes of the contract terms. This means for each specific root product the third column changes as database is updated. For example if product change from liquid chemical to solid plate and from Japan marketplace to Germany the following changes take place in the third column:

a) pounds instead of units

b) 1000 liters instead of 100 units

c) Euro instead of Japanese Yen

d) calendar month in place of 30-day or 60-day

e) tick value (minimum fluctuation) 1 point instead of 5

f) marketplace (Frankfurt instead of Tokyo)

g) daily limit (5% instead of 10%)

h) initial margin (10% instead of 15%)

i) physical delivery instead of cash offset

As product is specified, the system will update or adjust the contract property for lot size, product specification and tick value. It also adjusts the daily limit and performance bond required for the contract. The system also adjusts hours of trading and the currency of trade based on selected marketplace. In this manner a general condition of contract is modified to reflect a particular condition of contract, that is, certain requirements of the forward contract. The semi-custom contract is universal implying that it can be used in different marketplaces and in different environment. The main characteristics simply change as key factors such as product, delivery date, etc. change.

This type of contract is a flexible financial instrument and is now ready to be traded in any trading platform.

The Trading Platform

A Hybrid Trading Platform(HTP) described below is specially suited for these flexible contracts. HTP has two components. The Marketplace and the Facility. Certain operational steps may be taken simultaneously.

1. The Marketplace refers to the processes that begin with participant's order placement and ends with participant's completing the transaction. Participants identity will remain anonymous throughout the process. Several steps take place as described below

A) Placing Orders:

The trading session, based on certain rules, define the beginning and end of period where orders may be placed. The period of trade is flexible; it could change at any time based on number of orders (bid or ask), the specific marketplace, the product, the contract specification and expected degree of liquidity. All orders are received, time-stamped and stored for matching purpose. The participant may select products based on products which are listed on screen. The participant also selects a particular delivery date as listed on screen

B) Order Processing:

The system after ensuring that the order is confirmed directs the order to a matching engine which then compares price, lot quantity and delivery time with available orders. Delivery dates are based on 30-day forward and multiples of that to conform with industry practices. It then generates a fair (best) price based on the match made. If no match takes place the order remain in the “bin” for the next cycle or session. The frequency of session depends on the number of matched orders. As the market becomes more liquid the frequency of session results in a continuous matching session. The unmatched order is retained until the end of the business day and then discarded unless the order type is good to cancel (GTC). In case a match is found by the end of the business day, the user is notified by email about the match. He can also check his orders on screen at any time to see his order status. For a cancellation, there will be no intimation.

### Liquidity Improvement

The need to create sufficient market liquidity can partially be achieved by trading a product which by itself is liquid. Alternatively, a market maker may be the catalyst for such liquidity. He will, however, require a price advantage from the so-called information trader who is merely interested in making a purchase or to sell his goods. The market maker is then a liquidity trader (without whom the hedgers are not able to participate) and is not just a buyer or seller of commodity. The issue here is availability of a favorable forward price spread that gives incentive to market maker. To induce such environment an advanced trade execution system is needed; it operates as a “trade assisted” market maker

Steps taken to improve liquidity occur at the initiation of private market practitioners searching for liquidity. A liquid market generates frequent transactions among buyers and sellers of contracts, irrespective of producers and consumers perceived to be the main participants.

a) Expanding the marketplace participants

The traditional marketplace participants such as Producers (manufacturer) and Consumers (next level of manufacturer and distributors) are basically “information” trader. To enlarge the scope of Participation it is necessary to provide a single platform where

Spot and forward contracts are traded on a single platform to accommodate producers and consumers

The underlying commodity is traded on the same platform to accommodate swap dealers

Single pricing is established for institutions and retail market to encourage retailer traders

Multi trading facilities in various locations are networked to accommodate local day traders and investors (speculators). The information sharing capability among all facilities will bring information trader and market makers to close proximity. In this fashion rapid price adjustments as well as price uniformity will take place.

Trading in local currencies (of trading facility) would allow products to be traded in an already liquid (currency) market. This will attract currency traders in otherwise liquid currency.

b) Improving the matching. The efficiency of open cry pit with respect to price discovery is superior to standard electronic matching where sequencing of orders prevents concurrent bid and ask as in an open cry pit. The following features, however, bring significant improvements to the marketplace.

Stop order (buy —cover short— if a specified amount or better/sell if a specified amount or better). Stop order when executed order becomes market order above or below the buy or sell order respectively. In this fashion potential matches will be any limit orders within their respective range.

Monitoring AND FLAGGING “inventory” position of limit orders, e.g. large limit buy or small limit sell indicating upward price trend.

Limiting the quantity to smaller lots for quicker match making

Centralized booking making all limit orders available to all traders. Implementation of centralized limit order, also known as Consolidated Limit Order Book, displays all limit orders in a centralized fashion allowing an aggregation of all limit orders to be available for automatic matching.

c) Specified price range associated with limit order. Limit order with price range can be provided by participant. Improvement will be made if ranges are defined by buyer and seller, the system limit order will have an attached “specified price range, i.e, buying if price is X(1+y %) or sell at X(1−-y %). This kind of marketing information is particularly applicable to corporate participants. Refer to FIG.'s

d) Aggregated price range associated with limit order

If limit order is not accompanied with price range an implied price range can be derived as follows:

Limit orders are arranged by price, starting with lowest sell-ascending and highest buy descending (followed by time it was submitted if market closed). Most matching techniques do not attempt to go beyond matching of single variable, such as price based on several parameters. Parameters remain fixed for any match. In an electronic pit we need to create a snap shot to view all (random) orders and identify all variables as criteria for matching. Standard way is to draw supply and demand curve and find the intersection point. Another alternative is to consider a reasonable range in which all bids and offers are sorted. We will then try to evaluate the number of bids and offers within the context of (80/20) Law of Distribution. That is finding the few prices that are most contested. This enhances the standard way of drawing supply and demand curve to locate the intersection point. The matching price will become more flexible and within a range. The matched orders are timed as FIFO. Improvement will be made as range is narrowed enough for market makers.

e) Discovering price based on price matching for a finite (sliced) time Limit orders generally are indicative of the range of price as per recent transactions. Averaging last cleared prices is X. Next bid is X−d, . . . and next offer is X+d′1 . . .

Period of session in which a match is made could be any time T in seconds or minutes depending on liquidity. For example: T=25 seconds

| # of orders | Bidding | # of orders | Asking |
|---|---|---|---|
| 2 | 5.00 | 1 | 5.05 |
| 1 | 4.98 | 3 | 5.02 |
| 4 | 4.97 | 4 | 5.04 |
| 5 | 4.98 | 6 | 5.01 |

There may be a number of matches here depending on limit and stop orders. Bid orders: 10+4.98+19.88+24.90=59.76/12=4.98 Offer orders: 5.05+15.06+20.16+30.06=70.33/14=5.02 Suggested match: 5.00

f) Narrowing range by applying 80/20 rule The matched orders are timed as FIFO. Improvement will be made if ranges become small enough where buyer and seller can quickly converge.

An approach to improving liquidity using 80/20 rule application is demonstrated below:

starting with price range, say, $5.000-$5.3000 Count all bid & ask Tabulate as follows:

| | |
|---|---|
| Total bid: 60 | total ask 40 |
| at 5.00-5.10:29 bid | 14 ask |
| at 5.11-5.20:16 bid | 15 ask |
| at 5.21-5.30:15 bid | 11 ask |
| 80% of all unmatched bid = 48 | 80% of all unmatched ask = 32 |

The price range is within 5.00 and 5.20

If we repeat this procedure counting the numbers at range from 5 to 5.2 the 80/20 result in a finer range, say, 5 to 5.10. Ultimately we arrive at averaging a set of numbers in the narrowest rage possible.

C) Risk Management:

To protect either party from financial risk the system implements the following procedures.

Performance bond: A cash bond at a pre-defined percentage-and dependent on contract—of contract amount is held in escrow account from both parties. The amount is maintained by the facility custodian until the contract expires or closes.

Bond maintenance: A marked-to-market procedure is employed to adjust the bond amount on daily basis. The reference to marked-to-market is made to spot price plus the carrying cost (if applicable) of contract. When sufficient market liquidity is available the reference will be shifted to designated forward contracts traded in a given period as short as 10 days. This means all, for example, 60-day forward contracts traded during last 10-days will assume to have same delivery date. Based on this price reference (if rising) an amount of maintenance margin may be added to original bond until the next day of adjustment. At the expiration of contract all such bonds and adjustments will be returned to the parties. FIG. 10 depicts this scenario where the 60 day contract is indicated by blue lines. For all 60-day contracts matched in a period of May 26 through May 31 all deliveries are pegged (or bunched) to a single fix date of July 10. This will allow a fixed date contract price be established upon which marked-to-market pricing for 60-day contract can be established. This implies that all contracts traded within a defined period will have their performance bond adjusted as if they all had a fixed delivery date of July 10.

In the event of default by either party the entire amount (original cash deposit plus any maintenance deposit) will be forfeited by the Facility

D) Market Data Dissemination:

As soon as the transaction is completed the results showing price, quantity traded and the time of trade will be posted on screen. This is an important piece of information for the next bid and ask process that helps narrow the price range.

2. The Facility performs the following functions. Most of these functions take place simultaneously with the Marketplace activity A) Product listing and maintenance: The participants will be able to select product as listed on screen. These products are methodically grouped and based on set of specifications instantly available to participants. The participant may request a product that is not listed, but can be considered equivalent. If such product exists the system will accept the request and proceeds with order placement. The system also provides “grading” of same product if physical delivery is required. Any premium or discount resulting from grading will be negotiated at the settlement.

B) Financial Clearing:

Matching and clearing take place concurrently. The process begins by establishing two separate Fiduciary and Escrow Accounts in a commercial bank. The Fiduciary account is for the purpose of accepting deposits from the participants and the Escrow account serves as a reading account.

Every participant is required to maintain a cash deposit in that account in proportion to his trading activity. The Fiduciary account is linked to an Escrow account which reflects the current trading activity of a participant at one time.

The fiduciary account acts as a common settlement account that allows the escrow account to withdraw from or deposit to at any time.

a) fiduciary account accepts deposits as they are tagged to an individual identifier (pin)

b) a two way fund transfer from fiduciary account to an escrow account takes place:

instruction from escrow account to fiduciary for blocking funds

instruction from escrow to fiduciary for transfer of blocked funds

instruction from escrow to fiduciary for re-deposit of funds

instruction from fiduciary to escrow for minimum threshold warning

c) continuous monitoring of fiduciary account and escrow account statements takes place.

d) fiduciary account allows withdrawal of any free funds (not blocked for trade)

Cash Management procedure:

a) When an order is placed the Facility automatically blocks the required performance cash bond in the Fiduciary account. As soon as the order is matched that amount will be electronically moved to Escrow account. At the settlement (the next day) the amount will be debited from participant's Fiduciary account and recorded accordingly.

b) If any adjustment to performance bond is needed the Facility will move money from Fiduciary to escrow account (and vice versa) and informs the participant immediately.

c) Cash Settlement To implement daily settlement, The Facility will make the following determination. If the adjusted price is above the contracted value The Facility will notify the customer to deposit additional money through electronic fund transfer. The requirement must be met within 24 hours. If the adjusted price is below the contracted value the customer will be entitled to request withdrawal of the additional fund

At the end of each trading day each participant's account is examined. If the contract is still not expired, but performance bond adjustment is required the money will be moved from Fiduciary account to Escrow account or vice versa.

If contract is terminated the required fund will be moved as credit or debit to either party based on settlement price of the contract

Step-by-step procedure

1. After logging in, the user will be able to monitor the prices of his selected product. Prices, in addition to spot, are forward 30-day, forward 60-day, and forward 90-day deliveries. The user is now ready to make a decision and he enters the trading platform. The user is instructed to provide the financial information needed for electronic fund transfer. This data is then imported onto instruction template that can then be recomposed as instruction to the designated commercial bank for “pulling”money out of user's account. The bank verifies user's bank information and pulls the amount from user's account as inputted by the user on visual banking screen. The fund is deposited at a segregated fiduciary account which is constantly monitored by the Facility administrator. One day after, the user will be able to view his account on screen to ensure the fund availability.

2. Next, the user places his order based on his trading strategy, including price information. The user will decide to buy or to sell, the product, quantity and the desired price. The period during which the order is valid can be a factor in the urgency and hence price. A day order is normally price sensitive. The order is created as outlined above. The Escrow data refers to a virtual account set up for user's trade activity. The account records the amount of transaction and credits/debits user's account accordingly. The user is immediately informed if his order is matched or not. The matching criteria is based on price for a given delivery. If no match is made the user is presented with nearest counter offers allowing him to modify his price accordingly

C) Physical Delivery Settlement

If at any time the contract is about to be expired against physical delivery the participant as buyer is notified in advance to deposit the additional fund needed for closing the contract. Assuming the contract expires in T days, an advanced notice of T-15 is sent electronically to buyer for the payment (balance). A second and final notice for payment is sent at T-10. There is a 48 hour window for buyer to deposit. In the case of the vendor the goods are expected to be at the designated warehouse at T-10; otherwise the final notice with 5-day window is transmitted to vendor. If at T-5 the goods have not been received (as indicated on designated warehouse computer screen) the vendor is in default.

If the fund is not deposited during the prescribed period the Platform notifies the participant of default, freezes the already collected cash bond and prepares for crediting the seller as final settlement.

If the situation is reversed and the seller has defaulted the Facility notifies the participant of default, freezes the already collected cash bond and enters into final settlement with buyer.

Physical Delivery procedure:

a) Prior to expiration of contract the participants are notified of delivery at a designated location that serves as bonded warehouse. The settlement aspect of this is as follows. The Facility will allow the goods be deposited at designated bonded warehouse. The vendor is legally protected by not issuing a bill of sale (or bill of lading) until an actual sale (match) is made and confirmed by the Facility. Order process—The bonded warehouse is networked to the Facility for real time communication including receiving/shipping instructions as well as BOL At T-5 and upon receipt of goods a pro-forma bill of lading with instructions is transmitted to warehouse. At T-1 the warehouse acknowledges arrival of goods at designated warehouse. At T buyer is contacted to pick up the goods at designated warehouse. Simultaneously fund is moved from the buyer's escrow account to seller's fiduciary account.

b) Collection & Deposit-An approved vendor will routinely deposit, or arrange for collection, the goods intended for sales at Facility designated warehouses. The designated bonded warehouse will, upon receipt of pro forma Bill Of Lading(BOL) from Facility will proceed to hand over the goods to buyer or its designated carrier.

c) Inspection and Grading—Inspection team—In an effort to minimize the rate of reject by the buyer and to guarantee a smooth operation a full time staff of professional inspectors conduct both physical and random lab test to determine the “grading” of the goods. The physical inspection includes the quantity counts, the packing standard, the ISO 9000 compliance, FCC certificate as well as any unusual physical appearance. The lab test includes performance and bench mark evaluation test as well as compatibility where applicable.

A trading example

The standard method of buying or selling generally fixes the price for delivery sometime in the future. In mid January 2003 the spot market price for 256 MB S DRAM in the US market was $3.10 (fixed lot quantity). If the order for 20,000 devices with delivery date of 30 days was placed (or received) on 15^{th} January, it would expect a payment of $3.10×20,000=$62,000 be made by 14^{th} February 2003.

On 14^{th} February when the delivery is made the spot price is $2.65 and the contract is worth $53,000

The difference of $9,000 resulting from price drop is due to the risk that (buyer) consumer took by assuming the price stability.

A solution:

HTP allows the manufacturer and the consumer (next stage of manufacturing) to continuously monitor and avoid any unexpected loss by hedging his position.

a) In the above example, on Jan. 16, 2003,

i) spot price was $3.10 and

ii) 30 day forward price was $2.88 (per device for minimum quantity of 1000)

The 30 day forward price is the forward adjusted price for 30 day delivery. The buy order for 20,000 devices is executed on the basis of 30 day forward price. The new contract price is then $57,600 (20,000×$2.88).

b) In mid February, the spot price is $2.65 and the same contract would be worth $53,000, but the difference between the spot price and delivery date price ($57,600) is narrowed from the original $9,000 to $4,400; the saving is more than 50%.

c) The buyer may now take delivery of the goods, or under cash-offset arrangement trade the contract without taking delivery. Under this scenario, he will offset his position against the market price before the expiration date.

1. A hybrid trading platform for buyers and sellers that will continuously provide a single forum for spot and forward contracts in a continuous double-sided auction style. The system comprising of:
means of supporting pre-trade including pricing data and technical data on the listed products;
means of creating advanced price and delivery matching engine comprising of user-defined limit order matching and aggregate-based limit order matching;
means of guaranteed trade by providing cash based performance bond;
means of supporting “post trade” activity including the financial clearing and settlement, cash based. The system further comprises a physical based settlement.

2. System of claim 1, wherein the trading platform lists a group of products with attached specification for trade. The listed product further contains a contract with fixed price and fixed quantity date.

3. System of claim 2, wherein the contract is bought and sold at specified delivery date.

4. System of claim 2, wherein contracts are traded daily for 30-day forward and multiples of that. The contracts are further re-traded on the same day and beyond up to a specified delivery date.

5. System of claim 1; wherein a cash based performance bond is provided.

6. System of claim 5, wherein the cash based performance bond is dependent on the product which is being traded.

7. System of claim 5, wherein the maintenance of performance bond comprises a continuously adjustment of cash based value based on marked-to market price.

8. System of claim 7, wherein the marked-to-market price is calculated based on a forward price of same contract at an assumed fixed delivery date.

9. An electronic book keeping technique performs clearing between two parties. The system comprising of two separate banking accounts residing at a commercial financial institution. The system further employs Automatic Clearing House (ACH) cash management system as an interface between the customer and the financial institution

10. System of claim 9, wherein an Escrow account is created to handle the clearing by means of transferring fund between a customer owned Fiduciary account and Escrow account.

11. System of claim 10, wherein the appropriate fund required for customer's trade activity is blocked at Fiduciary account. The trade activity is defined as placing specific buy or sell order

12. System of claim 11, wherein the blocked fund is electronically recorded in the Escrow account on as soon as a match for the placed order is made.

13. System of claim 10, further comprising: a means of cash settlement of trade. At the end of each trading day. The net amount of daily transaction is computed, credited to (or debited from) Fiduciary account.

14. A delivery system wherein, a designated bonded warehouse accepts delivered goods in standardized packaging format from a seller whose product has been listed in the trading platform, stores the said packages and dispatches the packages to the buyer's destination upon the contract expiration.

15. System of claim 14, wherein a physical delivery settlement of trade takes place upon payment from the buyer's Fiduciary account The system further comprising message transmittal to buyer and seller for delivery notification date

16. System of claim 1, wherein the market data resulted from executed trades and stored by the trading platform are posted and disseminated in real time. Such data reflect the latest price and volume of transactions at any time.

17. System of claim 1, wherein the matching is enhanced by the limit order associated with a price range

18. System of claim 1, wherein an aggregate price range from the limit orders is stored and matching attempt based on mean average of best range

19. System of claim 18, wherein Pareto's law is applied to pool of ranges to arrive at best possible matches within the most likely range.
